(19) United States
(12) Patent Application Publication
(10) Pub. No.: US 2025/0026439 A1
(43) Pub. Date: Jan. 23, 2025

(54) DRIVING SYSTEM AND SENSING RATCHET SET THEREOF ADAPTED FOR BIKE

(71) Applicant: DARFON ELECTRONICS CORP., Taoyuan City (TW)

(72) Inventor: Chang-Tai Chiang, Taoyuan City (TW)

(73) Assignee: DARFON ELECTRONICS CORP., Taoyuan City (TW)

(21) Appl. No.: 18/777,560

(22) Filed: Jul. 19, 2024

Related U.S. Application Data
(60) Provisional application No. 63/528,067, filed on Jul. 20, 2023.

(51) Int. Cl. B62M 6/50; B62M 6/60

(52) U.S. Cl. CPC B62M 6/50; B62M 6/60

(57) ABSTRACT

A bike driving system includes a chainring, a chain, a cassette sprocket and a sensing ratchet set. The cassette sprocket and the chainring are synchronously linked through the chain. The sensing ratchet set is connected to the cassette sprocket. The sensing ratchet set includes a ratchet base, a ratchet shell, a bottom case and a bike rotation speed sensor. The ratchet shell is rotatably disposed on the ratchet base. The bottom case is rotatably disposed at an end of the ratchet base. The bike rotation speed sensor is configured to sense a rotation speed of the ratchet base relative to the bottom case. If a gear ratio of the cassette sprocket to the chainring is between 1 and 0.5, and when the chainring rotates once in a full circle, a number of pulse signals output by the bike rotation speed sensor is between 24 and 150.

### CROSS REFERENCE TO RELATED APPLICATION

This application claims the benefit of U.S. Provisional Application No. 63/528,067, filed on Jul. 20, 2023. The content of the application is incorporated herein by reference.

### BACKGROUND OF THE INVENTION

### 1. Field of the Invention

The invention relates to a torque sensing architecture of a bike and, more particularly, to a driving system and a sensing ratchet set thereof adapted for a bike.

### 2. Description of the Prior Art

As smart travel required by people continues to increase, power-assisted bikes are becoming more and more popular. At present, the power-assisted bikes with a torque sensor need to rely on the cooperation of pedaling frequency and pedaling direction to better control the start, power off and power assist of a motor.

### SUMMARY OF THE INVENTION

The invention provides a sensing ratchet set capable of effectively improving transmission sensitivity of a rear wheel and a bike equipped with the sensing ratchet set, so as to solve the aforesaid problems.

According to an embodiment of the invention, a bike driving system comprises a chainring, a chain, a cassette sprocket and a sensing ratchet set. The chainring rotates with human input. The chain is connected to the chainring. The cassette sprocket comprises a plurality of sprockets coaxially stacked on a rear axle. The cassette sprocket is connected to the chain through one of the plurality of sprockets, such that the cassette sprocket is driven by the chain and synchronously linked with the chainring. The sensing ratchet set is axially connected to a side of the cassette sprocket. The sensing ratchet set comprises a ratchet base, a ratchet shell, a bottom case and a bike rotation speed sensor. The ratchet shell is rotatably disposed on the ratchet base. The bottom case is rotatably disposed at an end of the ratchet base. The bike rotation speed sensor is disposed between the ratchet base and the bottom case. The bike rotation speed sensor is configured to sense a rotation speed of the ratchet base relative to the bottom case. If a gear ratio of the cassette sprocket to the chainring is between 1 and 0.5, and when the chainring rotates once in a full circle, a number of pulse signals output by the bike rotation speed sensor is between 24 and 150.

According to another embodiment of the invention, a sensing ratchet set comprises a ratchet base, a ratchet shell, a bottom case and a bike rotation speed sensor. The ratchet shell is rotatably disposed on the ratchet base. The bottom case is rotatably disposed at an end of the ratchet base. The bike rotation speed sensor is disposed between the ratchet base and the bottom case. The bike rotation speed sensor is configured to sense a rotation speed of the ratchet base relative to the bottom case. The bike rotation speed sensor comprises a bike rotation speed sensing component and a bike rotation speed sensing module. The bike rotation speed sensing component is fixed to the ratchet base. The bike rotation speed sensing module is fixed to the bottom case and opposite to the bike rotation speed sensing component. When the ratchet base rotates with respect to the bottom case, the bike rotation speed sensing module senses the bike rotation speed sensing component to output a plurality of first bike rotation speed pulse signals and a plurality of second bike rotation speed pulse signals. A phase difference between the plurality of first bike rotation speed pulse signals and the plurality of second bike rotation speed pulse signals is 90 degrees.

As mentioned in the above, the sensing ratchet set of the invention is disposed on the cassette sprocket of a rear driving module. If a gear ratio of the cassette sprocket to the chainring is between 1 and 0.5, and when the crank rotates once in a full circle, the number of pulse signals output by the bike rotation speed sensor is between 24 and 150. Accordingly, when the gear ratio is smaller than 1, the invention can effectively increase the number of pulse signals output by the bike rotation speed sensor, thereby improving transmission sensitivity of a rear wheel of the bike. In an embodiment of the invention, a phase difference between a plurality of first bike rotation speed pulse signals and a plurality of second bike rotation speed pulse signals output by the bike rotation speed sensing module may be 90 degrees, so as to increase the number of pulse signals output by the bike rotation speed sensor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic view illustrating a bike according to an embodiment of the invention.

FIG. 2 is a side view illustrating a rear driving module shown in FIG. 1.

FIG. 3 is an exploded view illustrating the rear driving module shown in FIG. 2.

FIG. 4 is a perspective view illustrating a sensing ratchet set shown in FIG. 3 from another viewing angle.

FIG. 5 is an exploded view illustrating the sensing ratchet set shown in FIG. 3.

FIG. 6 is a perspective view illustrating a ratchet shell shown in FIG. 5.

FIG. 7 is a perspective view illustrating a ratchet base shown in FIG. 5.

FIG. 8 is a top view illustrating a bike rotation speed sensor shown in FIG. 5.

FIG. 9 is a perspective view illustrating a reverse rotation speed sensor shown in FIG. 5.

FIG. 10 is a schematic view illustrating a pulse signal in digital form.

FIG. 11 is a schematic view illustrating a pulse signal in analog form.

FIG. 12 is a top view illustrating a bike rotation speed sensor according to another embodiment of the invention.

FIG. 13 is a perspective view illustrating a reverse rotation speed sensor according to another embodiment of the invention.

### DETAILED DESCRIPTION

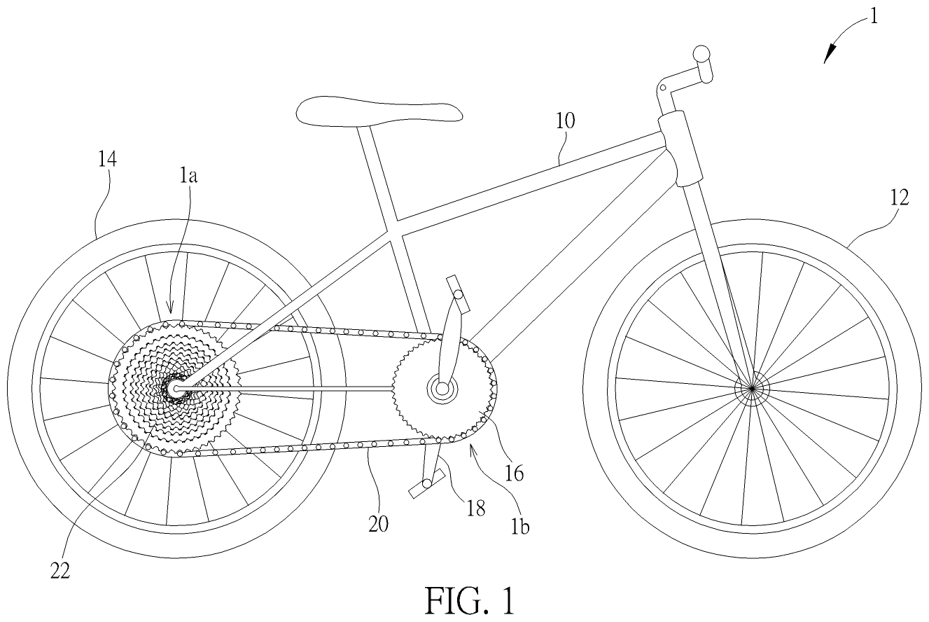

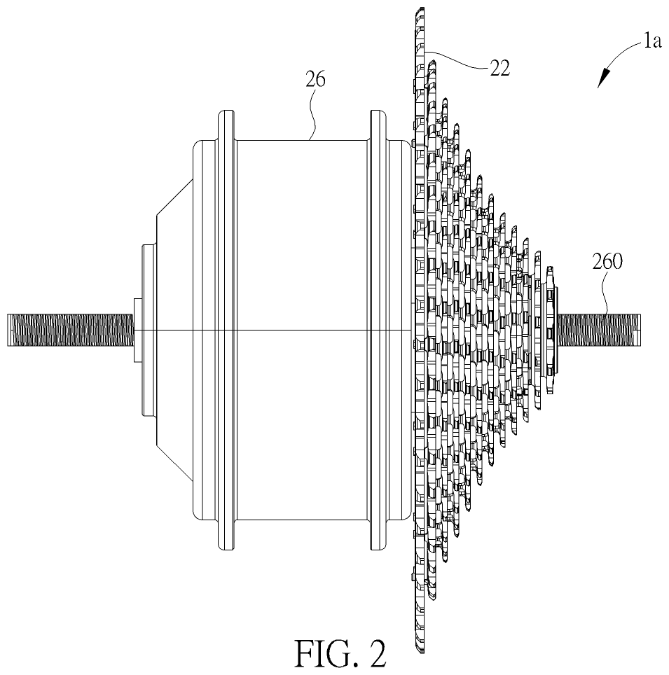

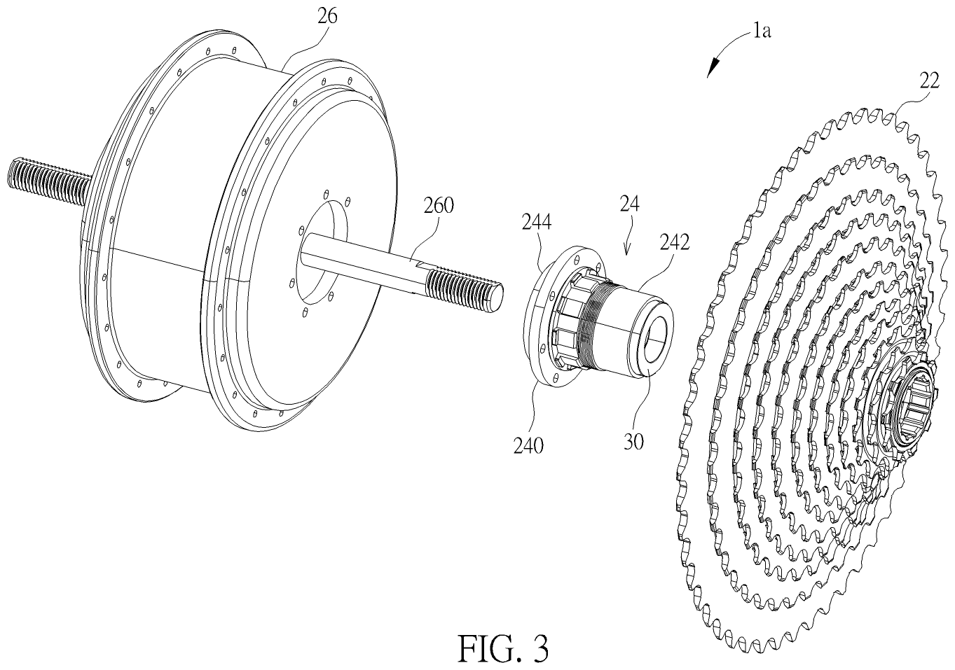

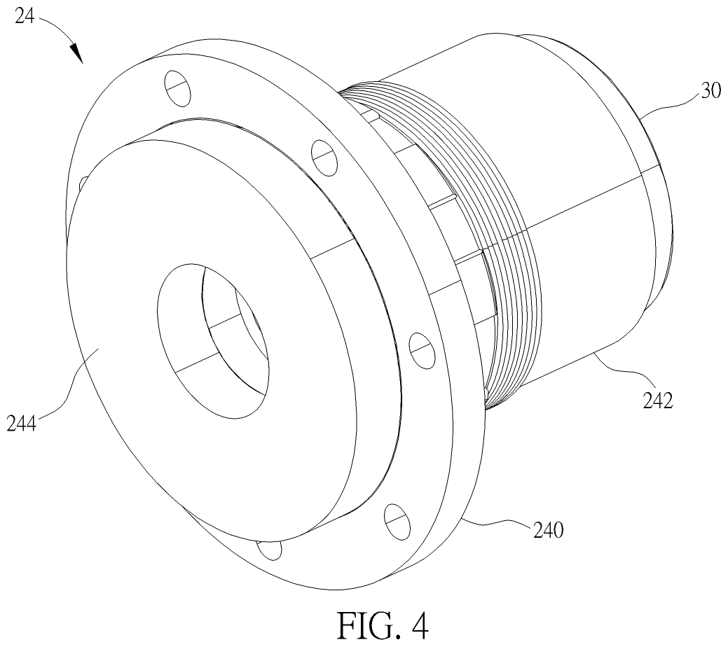

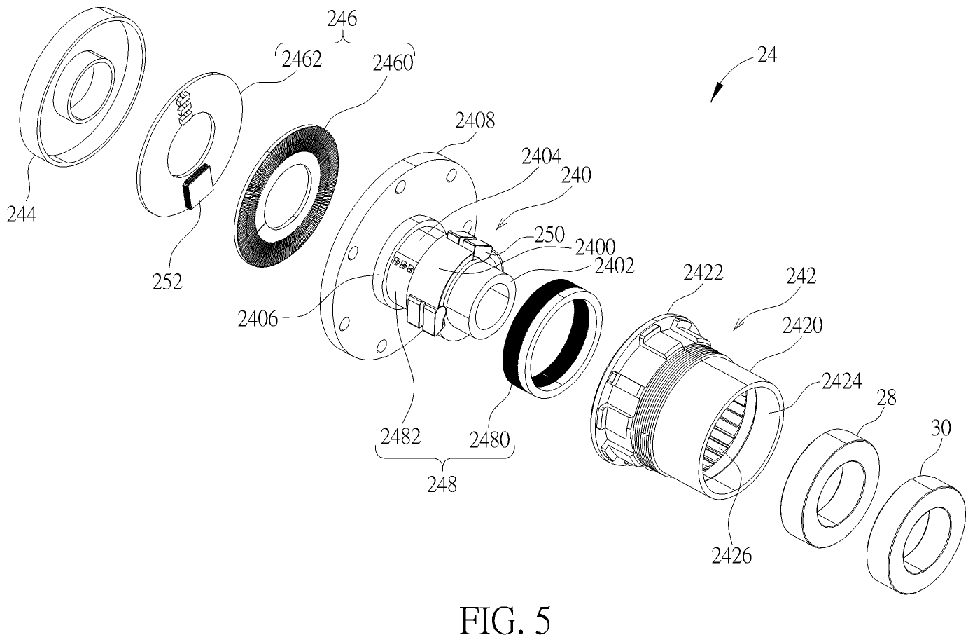

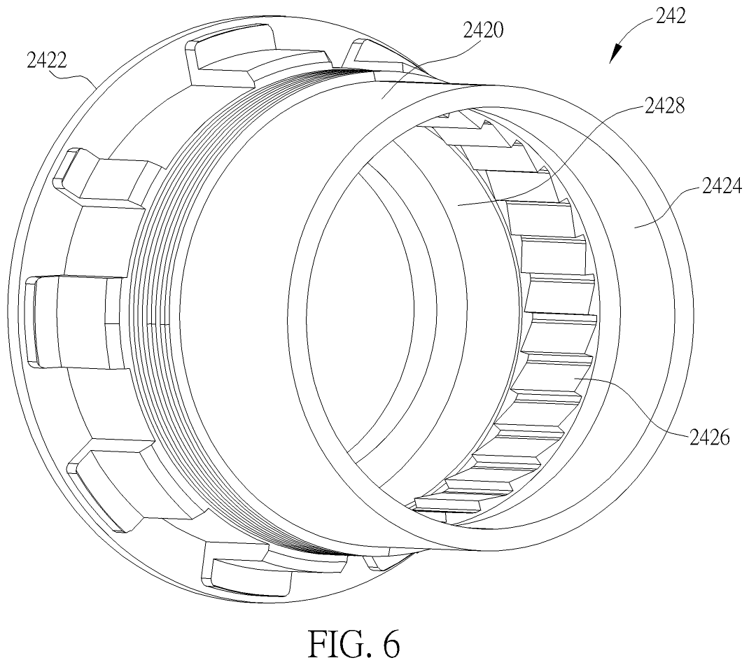

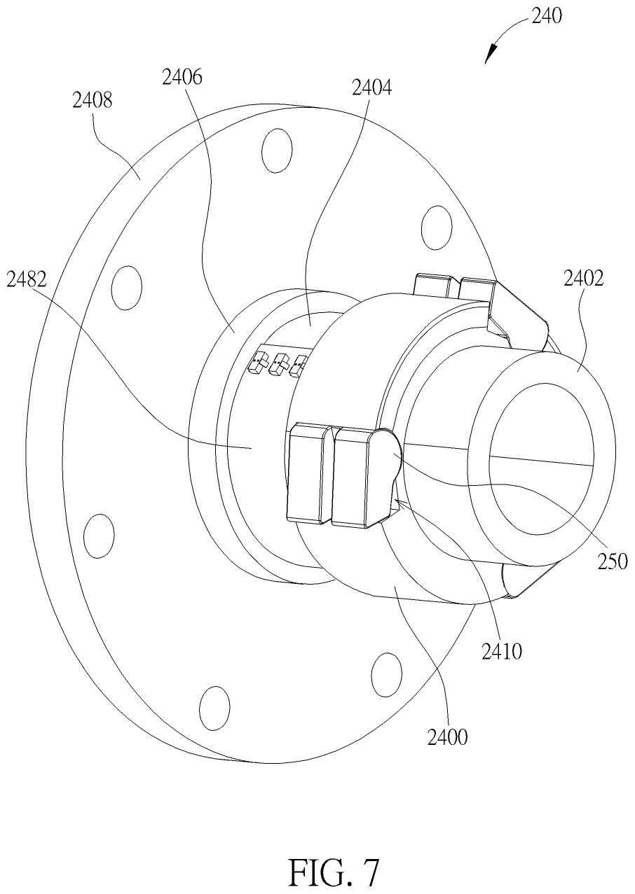

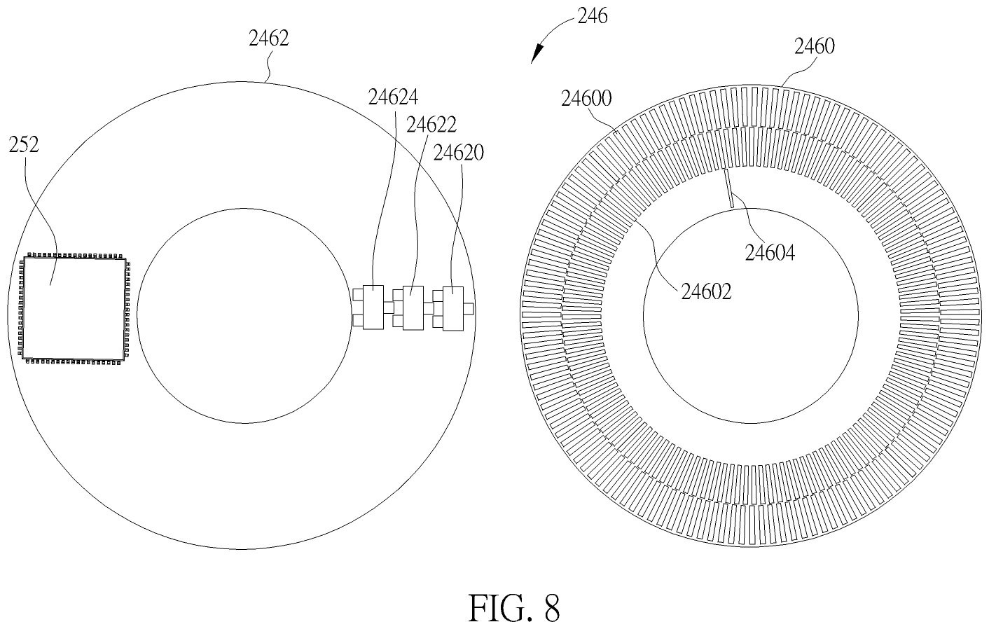

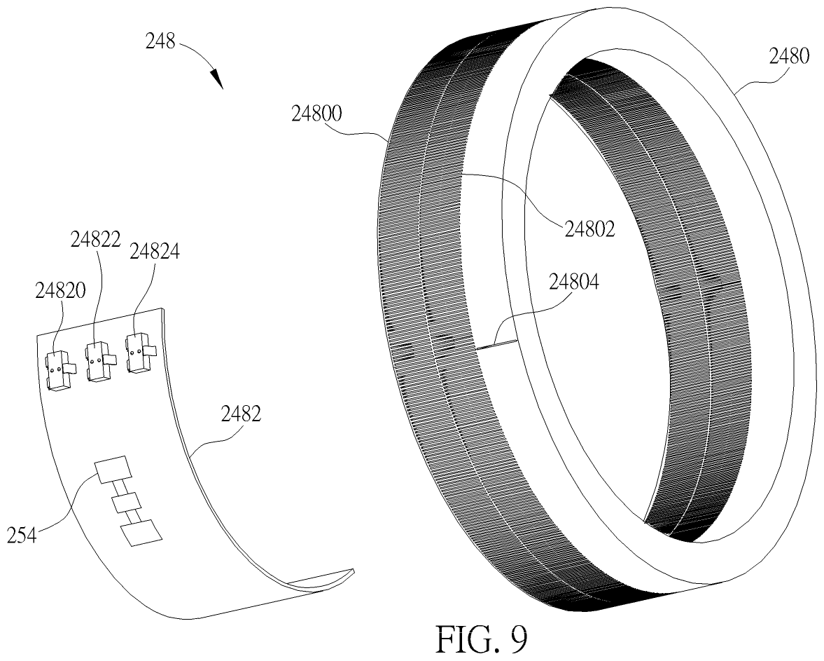

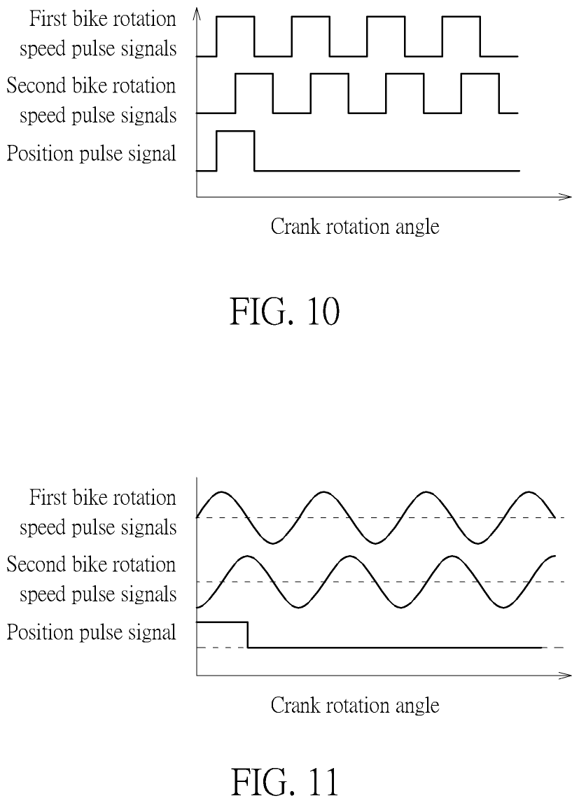

Please refer to FIGS. 1 to 11 for the power sensing of a bike in the following embodiments of the invention. FIG. 1 is a schematic view illustrating a bike 1 according to an embodiment of the invention, FIG. 2 is a side view illustrating a rear driving module 1a shown in FIG. 1, FIG. 3 is an exploded view illustrating the rear driving module 1a shown in FIG. 2, FIG. 4 is a perspective view illustrating a sensing ratchet set 24 shown in FIG. 3 from another viewing angle, FIG. 5 is an exploded view illustrating the sensing ratchet set 24 shown in FIG. 3, FIG. 6 is a perspective view illustrating a ratchet shell 242 shown in FIG. 5, FIG. 7 is a perspective view illustrating a ratchet base 240 shown in FIG. 5, FIG. 8 is a top view illustrating a bike rotation speed sensor 246 shown in FIG. 5, FIG. 9 is a perspective view illustrating a reverse rotation speed sensor 248 shown in FIG. 5, FIG. 10 is a schematic view illustrating a pulse signal in digital form, and FIG. 11 is a schematic view illustrating a pulse signal in analog form.

As shown in FIGS. 1 to 3, the bike 1 comprises a bike frame 10, a front wheel 12, a rear wheel 14, a rear driving module 1a and a front driving module 1b. The bike 1 further comprises a battery (not shown) disposed in the bike frame 10 to provide power for a motor 26. In order to focus on the embodiments of the invention, a few components are omitted and not introduced. The bike frame 10 may be broadly defined here. For example, in addition to a rigid frame body straddling the front wheel 12 and the rear wheel 14, the bike frame 10 further comprises a handle bar on the front side of the frame, a saddle, a front fork (not labeled) connecting the handle bar/front end of the frame/front wheel, and a seat stay (not labeled) and a chain stay (not labeled) connecting the rear end of the frame and the rear wheel 14. The rear driving module 1a and the front driving module 1b constitute a driving system of the bike 1. The rear driving module 1a comprises a motor 26, a sensing ratchet set 24 and a cassette sprocket 22 arranged coaxially with the rear wheel 14. The front driving module 1b comprises a chainring 16, a crank 18 and a chain 20 pivoted together as one unit. The front wheel 14 and the rear wheel 12 are rotatably disposed on the front and rear sides of the bike frame 10 respectively. The chainring 16 is rotatably disposed at the middle of the bike frame 10. The chainring 16 rotates with human input. The chain 20 is connected to the chainring 16. The crank 18 and the chainring 16 are synchronously linked. In practical applications, two cranks 18 with pedals (not labeled) are respectively disposed on opposite sides of the chainring 16, and the two cranks 18 may be linked through a bottom bracket (not labeled). The chain 20 is sleeved on the chainring 16 of the front driving module 1b and the cassette sprocket 22 of the rear driving module 1a, such that the cassette sprocket 22 and the chainring 16 are synchronously linked through the chain 20. Accordingly, the front wheel 12 and the rear wheel 14 will also rotate simultaneously. However, depending on the similarities and differences in the number of teeth on the cassette sprocket 22 and the chainring 16, the front wheel 12 and the rear wheel 14 may also rotate at the same or different speeds. The motor 26 of the rear driving module 1a has a rear axle 260 sequentially passing through the sensing ratchet set 24 and the cassette sprocket 22, such that the sensing ratchet set 24 is connected between the cassette sprocket 22 and the motor 26, and the motor 26, the sensing ratchet set 24 and the cassette sprocket 22 are coaxial. The rear axle 260 of the motor 26 also passes through the rear wheel 14, such that the output power of the motor 26 may be directly applied to the rear wheel 14. In other words, the rear wheel 14, the motor 26, the sensing ratchet set 24 and the cassette sprocket 22 are arranged coaxially. Furthermore, the cassette sprocket 22 comprises a plurality of sprockets coaxially stacked on the rear axle 260, and the cassette sprocket 22 is connected to the chain 20 through one of the plurality of sprockets, such that the cassette sprocket 22 is driven by the chain 20 and synchronously linked with the chainring 16. In general, a set of front/rear transmission kits (not shown) will be disposed on the chain 20 to allow the chain 20 to move and switch between different sprockets of the cassette sprocket 22 and to adjust the chain 20 to maintain appropriate tightness after shifting.

The bike 1 may have two power sources including human power and electric power. The human power is that a user inputs pedaling force through the pedal/chainring 16 of the front driving module 1b. The electric power is provided by the battery to drive the rear driving module 1a to exert the rotational force of the motor 26 on the rear wheel 14. In order to accurately monitor changes in human input and supply power in a timely and appropriate amount, the bike 1 must be equipped with a plurality of sensing components to respectively monitor the rotation data of the rear driving module 1a on the rear wheel 14 and the front driving module 1b on the pedal/chainring 16.

In general, three conditions may be obtained by arranging the gear ratio (or speed ratio) of the chainring 16 and the cassette sprocket 22 with different numbers of teeth: 1) when the gear ratio of the chainring/cassette sprocket is 1:1 (the number of teeth of the chainring 16 to the number of teeth of the cassette sprocket 22), the number of rotations/unit time (speed) of the rear driving module 1a and the front driving module 1b are the same; 2) when the gear ratio of the chainring/cassette sprocket is larger than 1, the number of rotations of the rear driving module 1a per unit time will be larger than the number of rotations of the front driving module 1b; 3) when the gear ratio of the chainring/cassette sprocket is smaller than 1, the number of rotations of the rear driving module 1a per unit time will be smaller than the number of rotations of the front driving module 1b.

The problem is that if the design logic of a power device of an unassisted bike is adopted, medium-speed and high-speed riding are the main requirements, i.e. the design focus falls on the condition where the gear ratio of the aforesaid items 1) and 2) is larger than or equal to 1. At this time, the best place to install a torque sensor is in the front driving module 1b, especially the coaxially rotating bottom bracket, pedal and chainring, because the purpose of the torque sensor is to provide human power output data for a rider for reference. At this time, even if the sensing component located in the front driving module 1b only has low sensitivity, it still can be used. On the other hand, when encountering a hill climb or a rough road, the speed of the bike 1 suddenly drops, i.e. the number of rotations of the rear wheel 14 and the rear driving module 1a decreases rapidly. If the rider relies on the sensing component installed in the front driving module 1b or the torque sensor is disposed in the front driving module 1b, there is often not enough response time to detect the deceleration problem and the sudden increase in the need for assistance. Thus, the embodiment of the invention disposes the sensing ratchet set 24 including the sensing component on the rear driving module 1a. The problem is that the sensitivity will be too low if the general sensing component used in the front driving module 1b is directly mounted on the rear wheel 14, and simply increasing the sensitivity cannot solve the torque detection problem of the rear wheel 14. Therefore, the sensing ratchet set 24 disclosed in the embodiment of the invention needs to be further adjusted and designed.

As shown in FIGS. 4 to 9, the sensing ratchet set 24 comprises a ratchet base 240, a ratchet shell 242, a bottom case 244, a bike rotation speed sensor 246 and a reverse rotation speed sensor 248. The ratchet base 240 is rotatably connected to the motor 26 in the axial direction and may rotate with the motor 26 and the rear wheel 14. The ratchet shell 242 is rotatably disposed on the ratchet base 240, and the bottom case 244 is rotatably disposed at an end of the ratchet base 240. The bike rotation speed sensor 246 is disposed between the ratchet base 240 and the bottom case 244. The bike rotation speed sensor 246 is configured to sense a rotation speed of the ratchet base 240 relative to the bottom case 244, so as to obtain revolutions per minute (RPM) of the rear wheel 14 and use it to calculate the traveling speed of the bike 1. The reverse rotation speed sensor 248 is disposed between the ratchet base 240 and the ratchet shell 242. The reverse rotation speed sensor 248 is configured to sense a rotation speed of the ratchet shell 242 relative to the ratchet base 240. The bike rotation speed sensor 246 may be combined with the reverse rotation speed sensor 248 to determine the forward and reverse rotations of the chainring 16 and the cassette sprocket 22 and estimate the pedaling frequency of the chainring 16.

As shown in FIG. 7, the ratchet base comprises a pawl fitting portion 2400, a base bearing joint 2402, a deformation sensing portion 2404, a tension restraining portion 2406 and a load connecting portion 2408. The load connecting portion 2408, the tension restraining portion 2406, the deformation sensing portion 2404, the pawl fitting portion 2400 and the base bearing joint 2402 are formed integrally. At least three pawl mounting recesses 2410 are equidistantly formed on a surface of the pawl fitting portion 2400.

As shown in FIG. 6, the ratchet shell 242 comprises a shell body 2420 and a shell restraining portion 2422. The shell restraining portion 2422 is integrally formed at an end of the shell body 2420. When assembling the ratchet shell 242 and the ratchet base 240, one side of the load connecting portion 2408 has a clearance fit with the end of the shell restraining portion 2422, such that the tension restraining portion 2406 and the shell restraining portion 2422 cooperate with each other to achieve position restraining.

As shown in FIGS. 5 and 6, a shell bearing joint 2424 is disposed in the shell body 2420. A first bearing 28 is disposed in a gap between the shell body 2420 and the base bearing joint 2402 to achieve rotational connection. There is an interference fit between the first bearing 28 and the shell bearing joint 2424 in the shell body 2420. There is an interference fit between the first bearing 28 and the base bearing joint 2402. Through the aforesaid arrangement, the rotation fit between the ratchet shell 242 and the ratchet base 240 may be achieved. Furthermore, a second bearing 30 is further disposed in the shell body 2420. The second bearing 30 is located outside the base bearing joint 2402. Specifically, there is an interference fit between the second bearing 30 and an inner wall of the shell body 2420, and the second bearing 30 is configured to connect an external shaft.

As shown in FIGS. 5 to 7, a plurality of evenly distributed pawl teeth 2426 are disposed in the ratchet shell 242, and the inside of the ratchet shell 242 is sequentially provided with a shell restraining portion 2422, a fixing groove 2428, a ratchet tooth 2426 and a shell bearing joint 2424. The ratchet base 240 is provided with a pawl 250 that matches the pawl teeth 2426. There are at least three pawls 250, which correspond to the number of pawl mounting recesses 2410. The pawl 250 is installed in the corresponding pawl mounting recess 2410. At least three pawls 250 may be fixedly connected through a pawl wire spring (not shown). After assembly is completed, the positions of the pawls 250 and the pawl teeth 2426 correspond to each other to achieve mutual engagement. Since the pawl 250 and the pawl tooth 2426 are in one-way engagement, a one-way torque may be exerted on the ratchet base 240 through the ratchet shell 242. For further explanation, when forward pedaling exerts a torque on the ratchet shell 242, the pawl teeth 2426 and the pawls 250 on the ratchet shell 242 exert a one-way torque on the ratchet base 240. At this time, the ratchet shell 242 and the ratchet base 240 keep rotating synchronously, i.e. the ratchet shell 242 and the ratchet base 240 are relatively stationary. It should be noted that when the forward rotation speed of the ratchet base 240 is too fast and the forward pedaling speed is too slow, the ratchet shell 242 and the ratchet base 240 will rotate with respect to each other. When the reverse pedaling causes the ratchet shell 242 to rotate in the reverse direction, the ratchet shell 242 will also rotate with respect to the ratchet base 240. In this embodiment, the pawls 250 and the pawl teeth 2426 form a one-way clutch mechanism.

As shown in FIGS. 5 and 8, the bike rotation speed sensor 246 comprises a bike rotation speed sensing component 2460 and a bike rotation speed sensing module 2462. The bike rotation speed sensing component 2460 is fixed to the ratchet base 240. The bike rotation speed sensing module 2462 is fixed to the bottom case 244 and opposite to the bike rotation speed sensing component 2460. In this embodiment, the bike rotation speed sensing module 2462 and the bike rotation speed sensing component 2460 are arranged oppositely along an axial direction of the sensing ratchet set 24. When the crank 18 is stepped forward, the ratchet base 240 will rotate with respect to the bottom case 244. When the ratchet base 240 rotates with respect to the bottom case 244, the bike rotation speed sensing module 2462 will sense the bike rotation speed sensing component 2460 to output a plurality of first bike rotation speed pulse signals and a plurality of second bike rotation speed pulse signals. In this embodiment, a phase difference between the plurality of first bike rotation speed pulse signals and the plurality of second bike rotation speed pulse signals is 90 degrees.

In this embodiment, the bike rotation speed sensing module 2462 may comprise a first bike rotation speed sensor 24620 and a second bike rotation speed sensor 24622, wherein the first bike rotation speed sensor 24620 and the second bike rotation speed sensor 24622 are arranged linearly along a radial direction of the bike rotation speed sensing module 2462. Furthermore, the bike rotation speed sensing component 2460 may comprise a plurality of first bike rotation speed target units 24600 and a plurality of second bike rotation speed target units 24602, wherein the plurality of first bike rotation speed target units 24600 and the plurality of second bike rotation speed target units 24602 are arranged in two adjacent rings and are mutually offset. When the ratchet base 240 rotates with respect to the bottom case 244, the first bike rotation speed sensor 24620 senses the plurality of first bike rotation speed target units 24600 to output the plurality of first bike rotation speed pulse signals, and the second bike rotation speed sensor 24622 senses the plurality of second bike rotation speed target units 24602 to output the plurality of second bike rotation speed pulse signals. The first bike rotation speed pulse signals and the second bike rotation speed pulse signals may be used to obtain revolutions per minute (RPM) of the rear wheel 14 and the traveling speed of the bike 1. In this embodiment, the bike rotation speed sensing module 2462 may further comprise a position sensor 24624, wherein the first bike rotation speed sensor 24620, the second bike rotation speed sensor 24622 and the position sensor 24624 are arranged linearly along the radial direction of the bike rotation speed sensing module 2462. Furthermore, the bike rotation speed sensing component 2460 may further comprise a position target unit 24604. When the crank 18 rotates once in a full circle, the position sensor 24624 senses the position target unit 24604 to output a position pulse signal. The position pulse signal may be used to determine an absolute position of the rotating shaft.

In an embodiment, the first bike rotation speed sensor 24620, the second bike rotation speed sensor 24622 and the position sensor 24624 may be magnetic sensors, and the first bike rotation speed target units 24600, the second bike rotation speed target units 24602 and the position target unit 24604 may be formed by magnetizing at corresponding positions. In another embodiment, the first bike rotation speed sensor 24620, the second bike rotation speed sensor 24622 and the position sensor 24624 may be optical sensors, and the first bike rotation speed target units 24600, the second bike rotation speed target units 24602 and the position target unit 24604 may be formed by etching gratings at corresponding positions. In another embodiment, the first bike rotation speed sensor 24620, the second bike rotation speed sensor 24622 and the position sensor 24624 may be capacitive sensors, and the first bike rotation speed target units 24600, the second bike rotation speed target units 24602 and the position target unit 24604 may be formed by laying metal wires at corresponding positions.

In an embodiment, the first bike rotation speed pulse signals, the second bike rotation speed pulse signals and the position pulse signal may be digital signals, as shown in FIG. 10. In another embodiment, the first bike rotation speed pulse signals, the second bike rotation speed pulse signals and the position pulse signal may be analog signals, as shown in FIG. 11.

In this embodiment, if a gear ratio of the cassette sprocket 22 to the chainring 16 is between 1 and 0.5, and when the crank 18 rotates once in a full circle, a number of pulse signals output by the bike rotation speed sensor 246 is between 24 and 150 (i.e. when the ratchet base 240 rotates once in a full circle with respect to the bottom case 244, a number of pulse signals output by the bike rotation speed sensor 246 is between 24 and 150). In other words, the percentage of the gear ratio to the number of pulse signals is between 0.33% and 4.17%. Accordingly, when the gear ratio is smaller than 1, the invention can effectively increase the number of pulse signals output by the bike rotation speed sensor 246, thereby improving transmission sensitivity of a rear wheel of the bike 1.

As shown in FIGS. 5 and 9, the reverse rotation speed sensor 248 may comprise a reverse rotation speed sensing component 2480 and a reverse rotation speed sensing module 2482. The reverse rotation speed sensing component 2480 is fixed to the ratchet shell 242. The reverse rotation speed sensing module 2482 is fixed to the ratchet base 240 and opposite to the reverse rotation speed sensing component 2480. In this embodiment, the reverse rotation speed sensing module 2482 and the reverse rotation speed sensing component 2480 are arranged oppositely along a radial direction of the sensing ratchet set 24. When the crank 18 is stepped in the reverse direction, the ratchet shell 242 will rotate with respect to the ratchet base 240. When the ratchet shell 242 rotates with respect to the ratchet base 240, the reverse rotation speed sensing module 2482 will sense the reverse rotation speed sensing component 2480 to output a plurality of first reverse rotation speed pulse signals and a plurality of second reverse rotation speed pulse signals. In this embodiment, a phase difference between the plurality of first reverse rotation speed pulse signals and the plurality of second reverse rotation speed pulse signals is 90 degrees.

In this embodiment, the reverse rotation speed sensing module 2482 may comprise a first reverse rotation speed sensor 24820 and a second reverse rotation speed sensor 24822, wherein the first reverse rotation speed sensor 24820 and the second reverse rotation speed sensor 24822 are arranged linearly along an axial direction of the reverse rotation speed sensing module 2482. Furthermore, the reverse rotation speed sensing component 2480 comprises a plurality of first reverse rotation speed target units 24800 and a plurality of second reverse rotation speed target units 24802, wherein the plurality of first reverse rotation speed target units 24800 and the plurality of second reverse rotation speed target units 24802 are arranged in two adjacent rings and are mutually offset. When the ratchet shell 242 rotates with respect to the ratchet base 240, the first reverse rotation speed sensor 24820 senses the plurality of first reverse rotation speed target units 24800 to output the plurality of first reverse rotation speed pulse signals, and the second reverse rotation speed sensor 24822 senses the plurality of second reverse rotation speed target units 24802 to output the plurality of second reverse rotation speed pulse signals. The first reverse rotation speed pulse signals and the second reverse rotation speed pulse signals may be combined with the aforesaid first bike rotation speed pulse signals and second bike rotation speed pulse signals to determine the forward and reverse rotations of the chainring 16 and the cassette sprocket 22 and estimate the pedaling frequency of the chainring 16. In this embodiment, the reverse rotation speed sensing module 2482 may further comprise a position sensor 24824, wherein the first reverse rotation speed sensor 24820, the second reverse rotation speed sensor 24822 and the position sensor 24824 are arranged linearly along the axial direction of the reverse rotation speed sensing module 2482. Furthermore, the reverse rotation speed sensing component 2480 may further comprise a position target unit 24804. When the crank 18 rotates once in a full circle, the position sensor 24824 senses the position target unit 24804 to output a position pulse signal. The position pulse signal may be used to determine an absolute position of the rotating shaft.

In an embodiment, the first reverse rotation speed sensor 24820, the second reverse rotation speed sensor 24822 and the position sensor 24824 may be magnetic sensors, and the first reverse rotation speed target units 24800, the second reverse rotation speed target units 24802 and the position target unit 24804 may be formed by magnetizing at corresponding positions. In another embodiment, the first reverse rotation speed sensor 24820, the second reverse rotation speed sensor 24822 and the position sensor 24824 may be optical sensors, and the first reverse rotation speed target units 24800, the second reverse rotation speed target units 24802 and the position target unit 24804 may be formed by etching gratings at corresponding positions. In another embodiment, the first reverse rotation speed sensor 24820, the second reverse rotation speed sensor 24822 and the position sensor 24824 may be capacitive sensors, and the first reverse rotation speed target units 24800, the second reverse rotation speed target units 24802 and the position target unit 24804 may be formed by laying metal wires at corresponding positions.

In an embodiment, the reverse bike rotation speed pulse signals, the second reverse rotation speed pulse signals and the position pulse signal may be digital signals. In another embodiment, the first reverse rotation speed pulse signals, the second reverse rotation speed pulse signals and the position pulse signal may be analog signals.

As shown in FIGS. 8 and 9, the sensing ratchet set 24 may further comprise a processor 252 and a torque measuring module 254, wherein the processor 252 may be disposed on the bike rotation speed sensing module 2462 and the torque measuring module 254 may be disposed on the reverse rotation speed sensing module 2482. The torque measuring module 254 is configured to measure a torque applied to the sensing ratchet set 24, such that the processor 252 may obtain a pedaling power based on the torque. For further explanation, the torque measuring module 254 may be disposed on the ratchet base 240 along with the reverse rotation speed sensing module 2482. The torque measuring module 254 is configured to sense a magnitude of a twisting deformation of an external force to obtain signals of the twisting deformation exerted by the external force. The torque measuring module 254 may be fixed to a surface of the deformation sensing portion 2404. The external force exerts torque on the ratchet shell 242 through the cassette sprocket 22. Through the mutual cooperation between the pawl teeth 2426 and the pawls 250, a torque is applied to the load connecting portion 2408 through the deformation sensing portion 2404. During the aforesaid process, the torque measuring module 254 will generate a deformation corresponding to the magnitude of the torque to obtain signals of the twisting deformation exerted by the external force. The processor 252 may control the motor 26 according to the signals of the twisting deformation exerted by the external force to achieve corresponding torque and speed control. The torque measuring module 254 may measure torque through strain gauges. Then, the processor 252 may multiply the torque by the rotation speed of the rear wheel to obtain pedaling power.

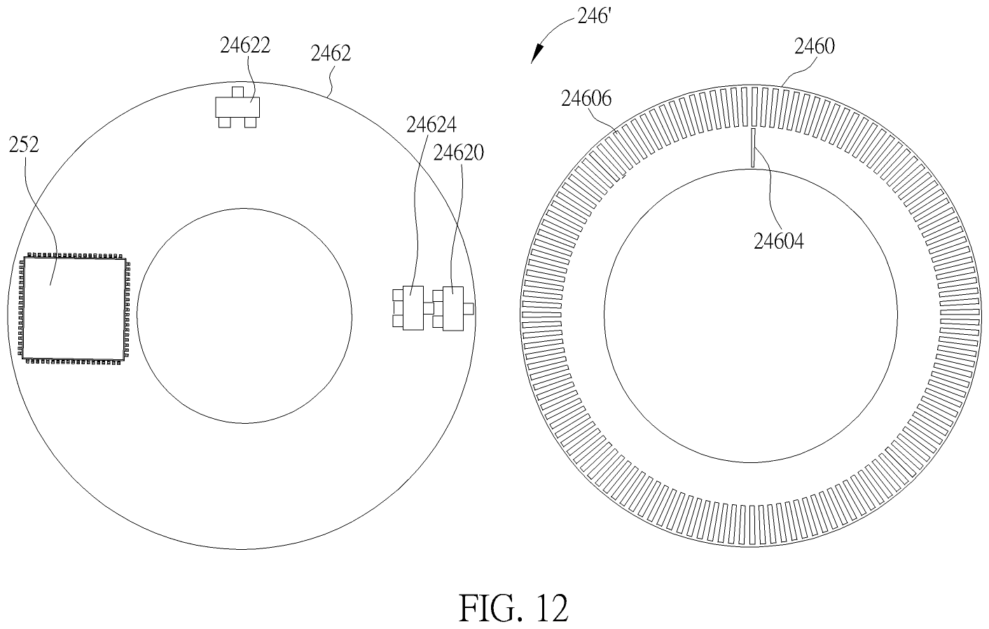

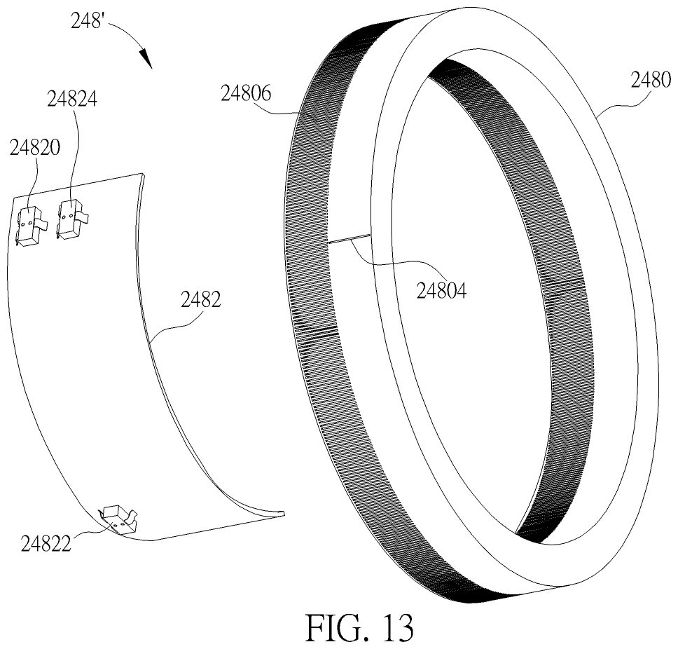

Referring to FIG. 12, FIG. 12 is a top view illustrating a bike rotation speed sensor 246′ according to another embodiment of the invention.

As shown in FIG. 12, the bike rotation speed sensing module 2462 of the bike rotation speed sensor 246′ comprises a first bike rotation speed sensor 24620, a second bike rotation speed sensor 24622 and a position sensor 24624, wherein the first bike rotation speed sensor 24620 and the second bike rotation speed sensor 24622 are arranged at an arc angle interval of 90 degrees, and the first bike rotation speed sensor 24620 and the position sensor 24624 are arranged linearly along a radial direction of the bike rotation speed sensing module 2462. Furthermore, the bike rotation speed sensing component 2460 of the bike rotation speed sensor 246′ comprises a plurality of bike rotation speed target units 24606 and a position target unit 24604, wherein the plurality of bike rotation speed target units 24606 are arranged in a ring.

The bike rotation speed sensor 246 shown in FIG. 5 may be replaced by the bike rotation speed sensor 246′ shown in FIG. 12. When the ratchet base 240 rotates with respect to the bottom case 244, the first bike rotation speed sensor 24620 senses the plurality of bike rotation speed target units 24606 to output the plurality of first bike rotation speed pulse signals, and the second bike rotation speed sensor 24622 senses the plurality of bike rotation speed target units 24606 to output the plurality of second bike rotation speed pulse signals. Furthermore, when the crank 18 rotates once in a full circle, the position sensor 24624 senses the position target unit 24604 to output a position pulse signal. It should be noted that the functions of the first bike rotation speed pulse signals, the second bike rotation speed pulse signals and the position pulse signal are as mentioned above and will not be described again herein.

Referring to FIG. 13, FIG. 13 is a perspective view illustrating a reverse rotation speed sensor 248′ according to another embodiment of the invention.

As shown in FIG. 13, the reverse rotation speed sensing module 2482 of the reverse rotation speed sensor 248′ comprises a first reverse rotation speed sensor 24820, a second reverse rotation speed sensor 24822 and a position sensor 24824, wherein the first reverse rotation speed sensor 24820 and the second reverse rotation speed sensor 24822 are arranged at an arc angle interval of 90 degrees, and the first reverse rotation speed sensor 24820 and the position sensor 24824 are arranged linearly along an axial direction of the reverse rotation speed sensing module 2482. Furthermore, the reverse rotation speed sensing component 2480 of the reverse rotation speed sensor 248′ comprises a plurality of reverse rotation speed target units 24806 and a position target unit 24804, wherein the plurality of reverse rotation speed target units 24806 are arranged in a ring.

The reverse rotation speed sensor 248 shown in FIG. 5 may be replaced by the reverse rotation speed sensor 248′ shown in FIG. 13. When the ratchet shell 242 rotates with respect to the ratchet base 240, the first reverse rotation speed sensor 24820 senses the plurality of reverse rotation speed target units 24806 to output the plurality of first reverse rotation speed pulse signals, and the second reverse rotation speed sensor 24822 senses the plurality of reverse rotation speed target units 24806 to output the plurality of second reverse rotation speed pulse signals. Furthermore, when the crank 18 rotates once in a full circle, the position sensor 24824 senses the position target unit 24804 to output a position pulse signal. It should be noted that the functions of the first reverse rotation speed pulse signals, the second reverse rotation speed pulse signals and the position pulse signal are as mentioned above and will not be described again herein.

As mentioned in the above, the sensing ratchet set of the invention is disposed on the cassette sprocket of a rear driving module. If a gear ratio of the cassette sprocket to the chainring is between 1 and 0.5, and when the crank rotates once in a full circle, the number of pulse signals output by the bike rotation speed sensor is between 24 and 150. Accordingly, when the gear ratio is smaller than 1, the invention can effectively increase the number of pulse signals output by the bike rotation speed sensor, thereby optimizing transmission sensitivity of a rear wheel of the bike. In an embodiment of the invention, a phase difference between a plurality of first bike rotation speed pulse signals and a plurality of second bike rotation speed pulse signals output by the bike rotation speed sensing module may be 90 degrees, so as to adjust the pulse signals output by the bike rotation speed sensor to the most appropriate number. Furthermore, although the bike in the aforesaid embodiment is equipped with a power source and a motor, the driving system and the sensing ratchet set of the invention may also be applied to a general bike without auxiliary power.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A bike driving system comprising
a chainring rotating with human input;
a chain connected to the chainring;
a cassette sprocket comprising a plurality of sprockets coaxially stacked on a rear axle, the cassette sprocket being connected to the chain through one of the plurality of sprockets, such that the cassette sprocket is driven by the chain and synchronously linked with the chainring; and
a sensing ratchet set axially connected to a side of the cassette sprocket, the sensing ratchet set comprising:
a ratchet base;
a ratchet shell rotatably disposed on the ratchet base;
a bottom case rotatably disposed at an end of the ratchet base; and
a bike rotation speed sensor disposed between the ratchet base and the bottom case, the bike rotation speed sensor being configured to sense a rotation speed of the ratchet base relative to the bottom case;
wherein if a gear ratio of the cassette sprocket to the chainring is between 1 and 0.5, and when the chainring rotates once in a full circle, a number of pulse signals output by the bike rotation speed sensor is between 24 and 150.

2. The bike driving system of claim 1, wherein the percentage of the gear ratio to the number of pulse signals is between 0.33% and 4.17%.

3. The bike driving system of claim 1, wherein the bike rotation speed sensor comprises:
a bike rotation speed sensing component fixed to the ratchet base; and
a bike rotation speed sensing module fixed to the bottom case and opposite to the bike rotation speed sensing component;
wherein, when the ratchet base rotates with respect to the bottom case, the bike rotation speed sensing module senses the bike rotation speed sensing component to output a plurality of first bike rotation speed pulse signals and a plurality of second bike rotation speed pulse signals; a phase difference between the plurality of first bike rotation speed pulse signals and the plurality of second bike rotation speed pulse signals is 90 degrees.

4. The bike driving system of claim 3, wherein the bike rotation speed sensing module comprises a first bike rotation speed sensor and a second bike rotation speed sensor, the first bike rotation speed sensor and the second bike rotation speed sensor are arranged linearly along a radial direction of the bike rotation speed sensing module, the bike rotation speed sensing component comprises a plurality of first bike rotation speed target units and a plurality of second bike rotation speed target units, the plurality of first bike rotation speed target units and the plurality of second bike rotation speed target units are arranged in two adjacent rings and are mutually offset, the first bike rotation speed sensor senses the plurality of first bike rotation speed target units to output the plurality of first bike rotation speed pulse signals, and the second bike rotation speed sensor senses the plurality of second bike rotation speed target units to output the plurality of second bike rotation speed pulse signals.

5. The bike driving system of claim 4, wherein the bike rotation speed sensing module further comprises a position sensor; the first bike rotation speed sensor, the second bike rotation speed sensor and the position sensor are arranged linearly along the radial direction of the bike rotation speed sensing module, the bike rotation speed sensing component comprises a position target unit; wherein, when the chainring rotates once in a full circle, the position sensor senses the position target unit to output a position pulse signal.

6. The bike driving system of claim 3, wherein the bike rotation speed sensing module comprises a first bike rotation speed sensor and a second bike rotation speed sensor, the first bike rotation speed sensor and the second bike rotation speed sensor are arranged at an arc angle interval of 90 degrees, the bike rotation speed sensing component comprises a plurality of bike rotation speed target units, the plurality of bike rotation speed target units are arranged in a ring, the first bike rotation speed sensor senses the plurality of bike rotation speed target units to output the plurality of first bike rotation speed pulse signals, and the second bike rotation speed sensor senses the plurality of bike rotation speed target units to output the plurality of second bike rotation speed pulse signals.

7. The bike driving system of claim 6, wherein the bike rotation speed sensing module further comprises a position sensor; the first bike rotation speed sensor and the position sensor are arranged linearly along a radial direction of the bike rotation speed sensing module, the bike rotation speed sensing component comprises a position target unit; wherein, when the chainring rotates once in a full circle, the position sensor senses the position target unit to output a position pulse signal.

8. The bike driving system of claim 1, wherein the sensing ratchet set further comprises a reverse rotation speed sensor disposed between the ratchet base and the ratchet shell, the reverse rotation speed sensor is configured to sense a rotation speed of the ratchet shell relative to the ratchet base, the reverse rotation speed sensor comprises:
a reverse rotation speed sensing component fixed to the ratchet shell; and
a reverse rotation speed sensing module fixed to the ratchet base and opposite to the reverse rotation speed sensing component;
wherein, when the ratchet shell rotates with respect to the ratchet base, the reverse rotation speed sensing module senses the reverse rotation speed sensing component to output a plurality of first reverse rotation speed pulse signals and a plurality of second reverse rotation speed pulse signals; a phase difference between the plurality of first reverse rotation speed pulse signals and the plurality of second reverse rotation speed pulse signals is 90 degrees.

9. The bike driving system of claim 8, wherein the reverse rotation speed sensing module comprises a first reverse rotation speed sensor and a second reverse rotation speed sensor, the first reverse rotation speed sensor and the second reverse rotation speed sensor are arranged linearly along an axial direction of the reverse rotation speed sensing module, the reverse rotation speed sensing component comprises a plurality of first reverse rotation speed target units and a plurality of second reverse rotation speed target units, the plurality of first reverse rotation speed target units and the plurality of second reverse rotation speed target units are arranged in two adjacent rings and are mutually offset, the first reverse rotation speed sensor senses the plurality of first reverse rotation speed target units to output the plurality of first reverse rotation speed pulse signals, and the second reverse rotation speed sensor senses the plurality of second reverse rotation speed target units to output the plurality of second reverse rotation speed pulse signals.

10. The bike driving system of claim 9, wherein the reverse rotation speed sensing module further comprises a position sensor; the first reverse rotation speed sensor, the second reverse rotation speed sensor and the position sensor are arranged linearly along the axial direction of the reverse rotation speed sensing module, the reverse rotation speed sensing component comprises a position target unit; wherein, when the chainring rotates once in a full circle, the position sensor senses the position target unit to output a position pulse signal.

11. The bike driving system of claim 8, wherein the reverse rotation speed sensing module comprises a first reverse rotation speed sensor and a second reverse rotation speed sensor, the first reverse rotation speed sensor and the second reverse rotation speed sensor are arranged at an arc angle interval of 90 degrees, the reverse rotation speed sensing component comprises a plurality of reverse rotation speed target units, the plurality of reverse rotation speed target units are arranged in a ring, the first reverse rotation speed sensor senses the plurality of reverse rotation speed target units to output the plurality of first reverse rotation speed pulse signals, and the second reverse rotation speed sensor senses the plurality of reverse rotation speed target units to output the plurality of second reverse rotation speed pulse signals.

12. The bike driving system of claim 11, wherein the reverse rotation speed sensing module further comprises a position sensor; the first reverse rotation speed sensor and the position sensor are arranged linearly along an axial direction of the reverse rotation speed sensing module, the reverse rotation speed sensing component comprises a position target unit; wherein, when the chainring rotates once in a full circle, the position sensor senses the position target unit to output a position pulse signal.

13. The bike driving system of claim 1, wherein the sensing ratchet set further comprises a processor and a torque measuring module, the torque measuring module is configured to measure a torque applied to the sensing ratchet set, and the processor obtains a pedaling power based on the torque.

14. A sensing ratchet set comprising:
a ratchet base;
a ratchet shell rotatably disposed on the ratchet base;
a bottom case rotatably disposed at an end of the ratchet base; and
a bike rotation speed sensor disposed between the ratchet base and the bottom case, the bike rotation speed sensor being configured to sense a rotation speed of the ratchet base relative to the bottom case, the bike rotation speed sensor comprising:
a bike rotation speed sensing component fixed to the ratchet base; and
a bike rotation speed sensing module fixed to the bottom case and opposite to the bike rotation speed sensing component;
wherein, when the ratchet base rotates with respect to the bottom case, the bike rotation speed sensing module senses the bike rotation speed sensing component to output a plurality of first bike rotation speed pulse signals and a plurality of second bike rotation speed pulse signals; a phase difference between the plurality of first bike rotation speed pulse signals and the plurality of second bike rotation speed pulse signals is 90 degrees.

15. The sensing ratchet set of claim 14, wherein, when the ratchet base rotates once in a full circle with respect to the bottom case, a number of pulse signals output by the bike rotation speed sensor is between 24 and 150.
